(19) United States
(12) Patent Application Publication
(10) Pub. No.: US 2010/0094812 A1
(43) Pub. Date: Apr. 15, 2010

(54) Dynamically Defining and Using a Delete Cascade Trigger Firing Attribute

(75) Inventors: Rafal Przemyslaw Konik, Oronoco, MN (US); Mark William Theuer, Rochester, MN (US); Michael Alan Venz, Rochester, MN (US)

Correspondence Address: IBM CORPORATION, 3605 HIGHWAY 52 NORTH, DEPT. 917, BUILDING 006-1, ROCHESTER, MN, 55901-7829, US

(73) Assignee: INTERNATIONAL BUSINESS MACHINES CORPORATION, Armonk, NY (US)

(21) Appl. No.: 12/251,223

(22) Filed: Oct. 14, 2008

(51) Int. Cl. G06F 17/30

(52) U.S. Cl. 707/690; 707/E17.005

(57) ABSTRACT

A method, computer program product or computer system for dynamically controlling the firing of a trigger for a DELETE CASECADE referential constraint in a database management system, which includes defining a DELETE CASCADE Trigger Fire Attribute (DCTFA) for each dependent file of the DELETE CASCADE referential constraint in a database, initializing each DCTFA with a value corresponding to enabling trigger firing or disabling trigger firing, and firing the trigger according to the value of the DCTFA of each dependent file during the DELETE CASCADE.

### BACKGROUND

1. Technical Field

The present invention relates to a database management system. More specifically, it relates to dynamically defining and utilizing a Delete Cascade Trigger Firing Attribute (DCTFA) in a relational database management system.

2. Background Information

A relational database stores data and relationships among the data into tables. A table in a relational database is two dimensional, where each row, the horizontal part of the table, contains a serial set of columns, and each column, the vertical part of the table, is related to a data type. A Relational Database Management System (RDBMS) creates, updates, and administers a relational database. Most commercial RDBMS's, e.g. DB2 of IBM, use the Structured Query Language (SQL) to access the database.

Using traditional file access terms, a physical file is a database file that stores application data. It contains a description of how data is to be presented to or received from a program and how data is actually stored in the database. A physical file includes fixed-length records that can have variable-length fields. It contains one record format and one or more members. From the perspective of the SQL interface, physical files are identical to tables.

Database files contain members and records. Members are different sets of data, each with the same format, within one database file. Before any input or output operation is performed on a file, the file must have at least one member. As a general rule, a database file has only one member, the one created when the file is created. If a file contains more than one member, each member serves as a subset of the data in the file. A record is a group of related data within a file. From the perspective of the SQL interface, records are identical to rows.

Referential integrity is the condition of a set of files in a database in which all references from one file to another are valid. Referential constraints can be added to ensure the referential integrity. In other words, referential constraints ensure that references from one file or a dependent file, to data in another file or the parent file, are valid.

Stated another way, if (1) a unique key is a column or set of columns in a table that uniquely identifies a row, (2) a primary key is a unique key that does not allow nulls, (3) a parent key is either a unique key or a primary key that is referenced in a referential constraint, (4) a foreign key is a column or set of columns whose values must match those of a parent key, (5) a parent table is a table that contains the parent key, (6) a dependent table is the table that contains the foreign key, and (7) a descendent table is a table that is a dependent table or a descendent of a dependent table, referential integrity is the state of a database in which all values of all foreign keys are valid. Each value of the foreign key must also exist in the parent key or be null. Enforcement of referential integrity prevents the violation of the rule that states that every non-null foreign key must have a matching non-null parent key. With a referential constraint, non-null values of the foreign key are valid only if they also appear as values of a parent key.

To define a referential constraint, a primary (or unique) key and a foreign key are specified, and rules that specify the action taken with respect to dependent rows when the parent row is deleted or updated are deleted and updated. After a referential constraint is defined, the system enforces the constraint on every INSERT, DELETE, and UPDATE operation performed through SQL or any other interface, e.g. IBM iSeries™ Navigator, command line (CL) commands, utilities, or high-level language statements.

When a file has a referential constraint, the referential constraint has a parent file and a dependent file with a column(s) that defines the relationship key between the two files. One of the parameters included when defining a referential constraint is the action to be taken when the parent key (record) is deleted from the parent file. For example, one of these actions is a DELETE CASCADED, which, when a parent key record is deleted from the parent file, deletes all the associated dependent key records from the dependent file.

A trigger is a set of actions that run automatically when a specified change or read operation is performed on a specified database file. The change operation can be an insert, update, or delete high-level language statement in an application program. The read operation can be a fetch, get, or read high-level language statement in an application program. Most systems have an environment, if a DELETE CASCADED referential constraint is defined between a parent file and dependent file, the system doesn't allow an SQL DELETE trigger to be added to the dependent file. If the system does allow the trigger to be added, then the deletion of a record in the parent file will cause associated records in the dependent file to be deleted. These cascaded deleted records in the dependent file will cause the SQL DELETE trigger to be fired multiple times—once for each record being deleted in the dependent file. Most users do not want a trigger being fired due to this condition, because it could result in the same trigger being fired many times because of the multiple cascaded deleted records. However, there are still times when this feature is demanded in an RDBMS.

### SUMMARY

A method, computer program product or computer system for dynamically controlling the firing of a trigger for a DELETE CASCADE referential constraint in a database management system, which includes defining a DELETE CASCADE Trigger Fire Attribute (DCTFA) for each dependent file of the DELETE CASCADE referential constraint in a database, initializing each DCTFA with a value corresponding to enabling trigger firing or disabling trigger firing, and firing the trigger according to the value of the DCTFA of each dependent file during the DELETE CASCADE.

### BRIEF DESCRIPTION OF DRAWINGS

FIG. 1 illustrates how a DCTFA is used in the present invention.

FIG. 2 is a flow chart showing the runtime steps of a database engine using the DCFTA.

FIG. 3 is a flow chart that illustrates how one embodiment of the present invention works with an after-delete trigger.

FIG. 4 is a flow chart that illustrates how one embodiment of the present invention works with a before-delete trigger.

FIG. 5 is a conceptual diagram of a computer system in which the present invention can be utilized.

### DETAILED DESCRIPTION

The invention will now be described in more detail by way of example with reference to the embodiments shown in the accompanying Figures. It should be kept in mind that the following described embodiments are only presented by way of example and should not be construed as limiting the inventive concept to any particular physical configuration. Further, if used and unless otherwise stated, the terms “upper,” “lower,” “front,” “back,” “over,” “under,” and similar such terms are not to be construed as limiting the invention to a particular orientation. Instead, these terms are used only on a relative basis.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable media may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the present invention, if an SQL DELETE trigger is defined on a dependent file of a referential constraint with a DELETE CASCADE, a Trigger Fire Attribute, the DELETE CASCADE Trigger Fire Attribute (DCTFA), is defined and will have impact on each DELETE CASCADE record. The DCTFA can be initially enabled to either fire, or not fire for a DELETE CASCADE record for a referential constraint. In various embodiments of the present invention, the enabling or disabling of DCTFA can also be accomplished through an interface to a database manager. This interface can be an API (Application Program Interface), a native command, a SQL statement, or an application program, etc. The attribute then allows the user to have control over when the trigger is fired for a cascade of deleted records. Also, the user would have the capability to dynamically change this attribute so a decision could be made prior to the primary delete in the parent file whether to enable or disable the DCTFA.

Therefore, the present invention enables a DELETE CASCADE trigger on a dependent file that can have its DCTFA dynamically enabled and disabled, which also offers a functional and performance enhancements, because the delete trigger can be defined for a dependent file at the time when the user is able to determine if the trigger should be fired, no matter when the DELETE CASACDE is performed on the parent file.

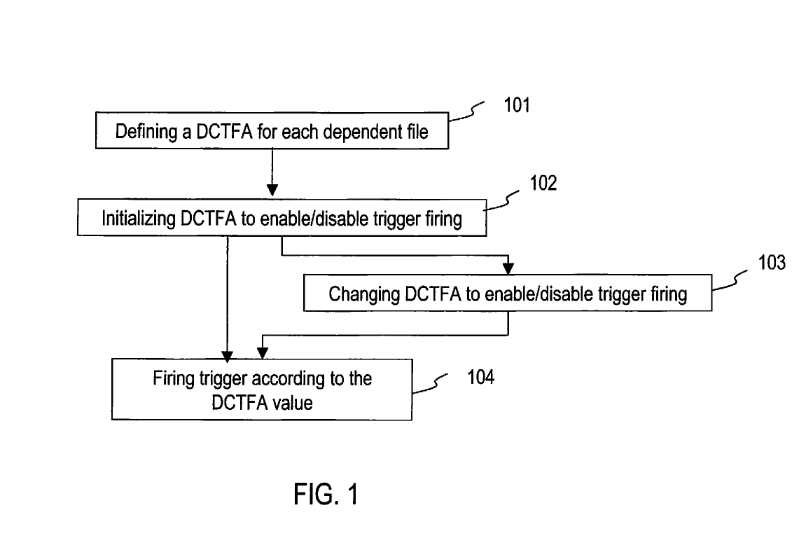

FIG. 1 illustrates how the DCTFA is used in the present invention. First, a DCTFA is defined for each dependent file of a DELETE CASCADE referential constraint in a database for a parent file (step 101). The DCTFA is then enabled with a value that corresponds to one of the two firing states: enabling trigger firing and disabling trigger firing (step 102). The trigger of each dependent file will then be fired according to its firing status according to the value of its DCTFA (step 104). The value of a DCTFA can be changed before the time to determine whether the trigger should be fired (step 103). In one embodiment of the present invention, the DCTFA is defined by a SQL CREATE TRIGGER statement, or alternately, by the native CL command ADDPFTRG. Since in SQL, triggers are file (or table) related, the DCTFA will be stored with a trigger definition in the related file.

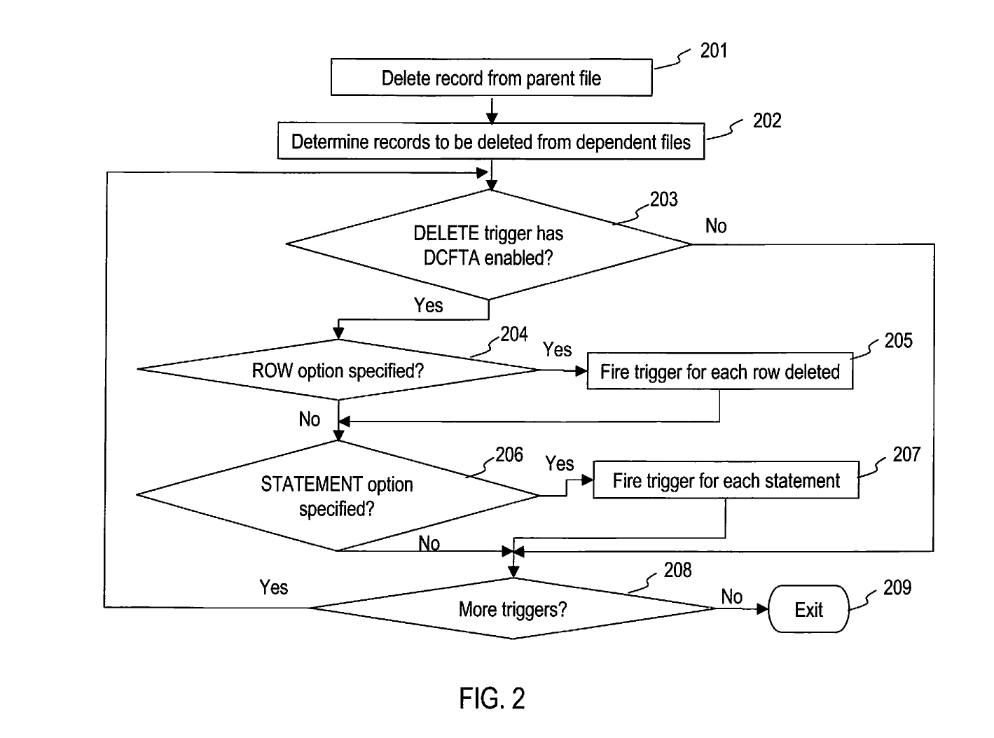

In one embodiment of the present invention, if triggers are defined for dependent files of a parent file with a DELETE CASCADE referential constraint, the database engine performs the following steps at runtime, as illustrated in FIG. 2.

1. Delete the record in the parent file (step 201).

2. Determine the records to be deleted in the dependent file (step 202).

3. Determine if there are any DELETE action triggers existing in the dependent file; and if so, determine whether each trigger has the DCFTA enabled (step 203). There may be more than one of these triggers. Continue to check other triggers (step 208) if one trigger does not have an enabled DCFTA.

4. For an enabled trigger, determine if a ROW or a STATEMENT option is specified (step 204 and step 206). A ROW option states that the trigger will be fired for each action on the ROW. The STATEMENT option states that the trigger will be fired once for the SQL statement (i.e. original delete) that started the DELETE CASCADE.

5. Fire the trigger for each row deleted (ROW option, step 205), or fire the trigger once (STATEMENT option, step 207), in the dependent file.

6. Repeat the steps 3-5 (step 203-step 207) until all DELETE triggers are examined (step 208).

There are two types of triggers. One type of trigger, the after-delete trigger, fires the trigger after a DELETE action, while the other type of trigger, the before-delete trigger, fires the trigger before a DELETE action.

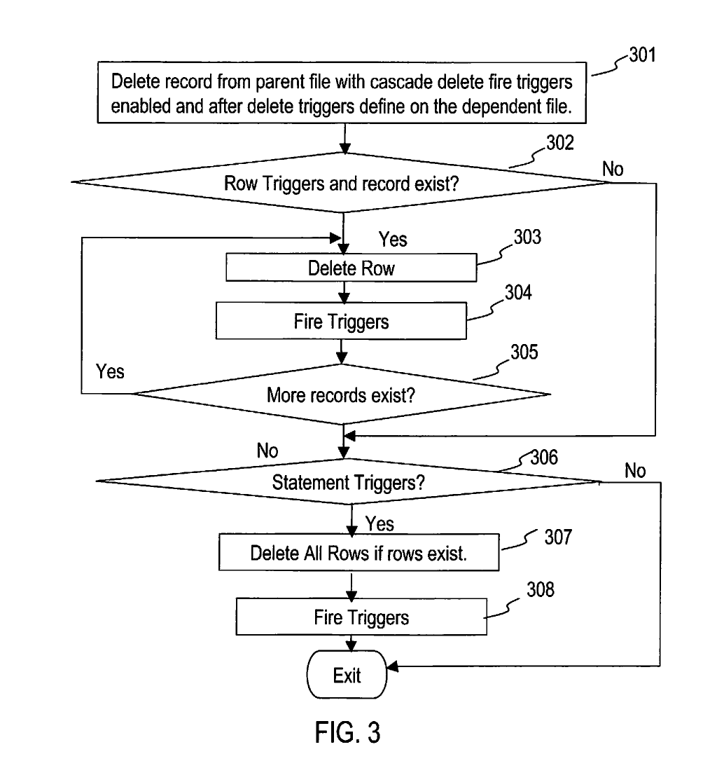

FIG. 3 is a flow chart that illustrates how one embodiment of the present invention works with an after-delete trigger. First records with DCFTA enabled and an after-delete trigger defined on its dependent file are deleted from the parent file (step 301). Step 302 determines whether triggers with a ROW option and the corresponding records exist. If the ROW option is specified, the row is deleted (step 303), and the trigger is fired (step 304). If there are more records (step 305), the steps 303-305 are repeated. Otherwise, the process continues from step 306. If there is no trigger with a ROW option specified in step 302, the process continues from step 306 to determine if there is a STATEMENT option specified for a trigger. If there is, all rows will be deleted (step 307) and the trigger is fired once (step 308).

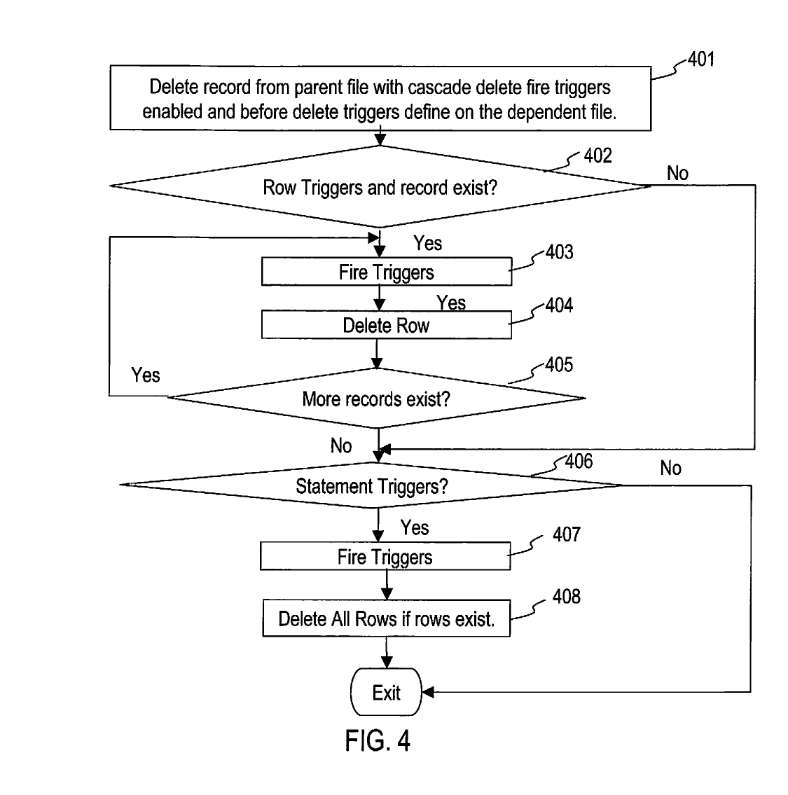

FIG. 4 is a flow chart that illustrates how one embodiment of the present invention works with a before-delete trigger. First records with DCFTA enabled and the before-delete trigger defined on its dependent file are deleted from the parent file (step 401). Step 402 determines whether triggers with a ROW option and the corresponding records exist. If the ROW option is specified, the trigger is fired (step 403), and the row is deleted (step 404). If there are more records (step 405), the steps 403-405 are repeated. Otherwise, the process continues from step 406. If there is no trigger with a ROW option specified in step 402, the process continues from step 406 to determine if there is a STATEMENT option specified for a trigger. If there is, the trigger is fired (step 407) and all rows will be deleted (step 408).

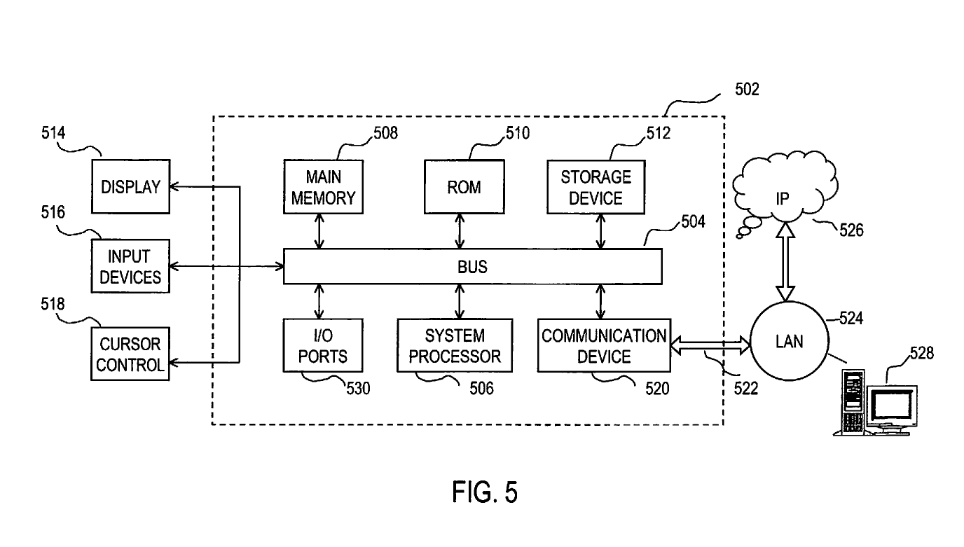

FIG. 5 illustrates a computer system (502) upon which the present invention may be implemented. The computer system may be any one of a personal computer system, a work station computer system, a lap top computer system, an embedded controller system, a microprocessor-based system, a digital signal processor-based system, a hand held device system, a personal digital assistant (PDA) system, a wireless system, a wireless networking system, etc. The computer system includes a bus (504) or other communication mechanism for communicating information and a processor (506) coupled with bus (504) for processing the information. The computer system also includes a main memory, such as a random access memory (RAM) or other dynamic storage device (e.g., dynamic RAM (DRAM), static RAM (SRAM), synchronous DRAM (SDRAM), flash RAM), coupled to bus for storing information and instructions to be executed by processor (506). In addition, main memory (508) may be used for storing temporary variables or other intermediate information during execution of instructions to be executed by processor. The computer system further includes a read only memory (ROM) 510 or other static storage device (e.g., programmable ROM (PROM), erasable PROM (EPROM), and electrically erasable PROM (EEPROM)) coupled to bus 504 for storing static information and instructions for processor. A storage device (512), such as a magnetic disk or optical disk, is provided and coupled to bus for storing information and instructions. This storage device is an example of a computer readable medium.

The computer system also includes input/output ports (530) to input signals to couple the computer system. Such coupling may include direct electrical connections, wireless connections, networked connections, etc., for implementing automatic control functions, remote control functions, etc. Suitable interface cards may be installed to provide the necessary functions and signal levels.

The computer system may also include special purpose logic devices (e.g., application specific integrated circuits (ASICs)) or configurable logic devices (e.g., generic array of logic (GAL) or re-programmable field programmable gate arrays (FPGAs)), which may be employed to replace the functions of any part or all of the method as described with reference to FIG. 1-FIG. 4. Other removable media devices (e.g., a compact disc, a tape, and a removable magneto-optical media) or fixed, high-density media drives, may be added to the computer system using an appropriate device bus (e.g., a small computer system interface (SCSI) bus, an enhanced integrated device electronics (IDE) bus, or an ultra-direct memory access (DMA) bus). The computer system may additionally include a compact disc reader, a compact disc reader-writer unit, or a compact disc jukebox, each of which may be connected to the same device bus or another device bus.

The computer system may be coupled via bus to a display (514), such as a cathode ray tube (CRT), liquid crystal display (LCD), voice synthesis hardware and/or software, etc., for displaying and/or providing information to a computer user. The display may be controlled by a display or graphics card. The computer system includes input devices, such as a keyboard (516) and a cursor control (518), for communicating information and command selections to processor (506). Such command selections can be implemented via voice recognition hardware and/or software functioning as the input devices (516). The cursor control (518), for example, is a mouse, a trackball, cursor direction keys, touch screen display, optical character recognition hardware and/or software, etc., for communicating direction information and command selections to processor (506) and for controlling cursor movement on the display (514). In addition, a printer (not shown) may provide printed listings of the data structures, information, etc., or any other data stored and/or generated by the computer system.

The computer system performs a portion or all of the processing steps of the invention in response to processor executing one or more sequences of one or more instructions contained in a memory, such as the main memory. Such instructions may be read into the main memory from another computer readable medium, such as storage device. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The computer system also includes a communication interface coupled to bus. The communication interface (520) provides a two-way data communication coupling to a network link (522) that may be connected to, for example, a local network (524). For example, the communication interface (520) may be a network interface card to attach to any packet switched local area network (LAN). As another example, the communication interface (520) may be an asymmetrical digital subscriber line (ADSL) card, an integrated services digital network (ISDN) card or a modem to provide a data communication connection to a corresponding type of telephone line. Wireless links may also be implemented via the communication interface (520). In any such implementation, the communication interface (520) sends and receives electrical, electromagnetic or optical signals that carry digital data streams representing various types of information.

Network link (522) typically provides data communication through one or more networks to other data devices. For example, the network link may provide a connection to a computer (526) through local network (524) (e.g., a LAN) or through equipment operated by a service provider, which provides communication services through a communications network (528). In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit notifications and receive data, including program code, through the network(s), the network link and the communication interface.

It should be understood, that the invention is not necessarily limited to the specific process, arrangement, materials and components shown and described above, but may be susceptible to numerous variations within the scope of the invention.

What is claimed is:

1. A computer-based method for dynamically controlling the firing of a trigger for a DELETE CASCADE referential constraint in a database management system, comprising:
defining a DELETE CASCADE Trigger Fire Attribute (DCTFA) for each dependent file of the DELETE CASCADE referential constraint in a database;
initializing each DCTFA with a value corresponding to one of enabling trigger firing and disabling trigger firing; and
firing the trigger according to the value of the DCTFA of each dependent file during the DELETE CASCADE.

2. The method of claim 1, further comprising changing the value of the DCFTA of a dependent file during the DELETE CASCADE.

3. The method of claim 1, wherein the firing comprises:
determining records to be deleted in the dependent files;
identifying the trigger for each of the dependent files;
determining whether the DCFTA is enabled for the trigger; and
firing each DCFTA-enabled trigger according to its firing option.

4. The method of claim 3, wherein the firing option is one of a ROW option and a STATEMENT option.

5. The method of claim 4, wherein, if the ROW option is specified, the trigger is fired for each action on a record of the dependent file.

6. The method of claim 5, wherein, if the STATEMENT option is specified, the trigger is fired once for a SQL statement that starts the DELETE CASCADE.

7. The method of claim 3, further comprising deleting a record in a parent file of the dependent files before deleting the records in the dependent files.

8. The method of claim 1, wherein the trigger either fires before deleting a record in one of the dependent files, or fires after deleting a record in one of the dependent files.

9. A computer program product to dynamically control the firing of a trigger for a DELETE CASCADE referential constraint in a database management system, the computer program product comprising:
a computer usable medium having computer usable program code embodied therewith, the computer usable program code comprising:
instructions to define a DCTFA for each dependent file of the DELETE CASCADE referential constraint in a database;
instructions to initialize each DCTFA with a value corresponding to one of enabling trigger firing and disabling trigger firing; and
instructions to fire the trigger according to the value of the DCTFA of each dependent file during the DELETE CASCADE.

10. The computer program product of claim 9, further comprising instructions to change the value of the DCFTA of a dependent file during the DELETE CASCADE.

11. The computer program product of claim 9, wherein the instructions to fire comprise:
instructions to determine records to be deleted in the dependent files;
instructions to identify the trigger for each of the dependent files;
instructions to determine whether the DCFTA is enabled for the trigger; and
instructions to fire each DCFTA-enabled trigger according to its firing option.

12. The computer program product of claim 11, wherein the firing option is one of a ROW option and a STATEMENT option.

13. The computer program product of claim 12, wherein, if the ROW option is specified, the trigger is fired for each action on a record of the dependent file.

14. The computer program product of claim 13, wherein, if the STATEMENT option is specified, the trigger is fired once for a SQL statement that starts the DELETE CASCADE.

15. The computer program product of claim 11, further comprising instructions to delete a record in a parent file of the dependent files before deleting the records in the dependent files.

16. The computer program product of claim 9, wherein the trigger either fires before deleting a record in one of the dependent files, or fires after deleting a record in one of the dependent files.

17. A computer system comprising:
a processor;
a memory operatively coupled with the processor;
a storage device operatively coupled with the processor and the memory; and
a computer program product configured to dynamically control the firing of a trigger for a DELETE CASCADE referential constraint in a database management system, the computer program product comprising:
a computer usable medium having computer usable program code embodied therewith, the computer usable program code comprising:
instructions to define a DCTFA for each dependent file of the DELETE CASCADE referential constraint in a database;
instructions to initialize each DCTFA with a value corresponding to one of enabling trigger firing and disabling trigger firing; and
instructions to fire the trigger according to the value of the DCTFA of each dependent file during the DELETE CASCADE.

18. The computer system of claim 17, further comprising instructions to change the value of the DCFTA of a dependent file during the DELETE CASCADE.

19. The computer system of claim 17, wherein the instructions to fire comprise:
instructions to determine records to be deleted in the dependent files;
instructions to identify the trigger for each of the dependent files;
instructions to determine whether the DCFTA is enabled for the trigger; and
instructions to fire each DCFTA-enabled trigger according to its firing option.

20. The computer system of claim 19, wherein the firing option is one of a ROW option and a STATEMENT option.

21. The computer system of claim 20, wherein, if the ROW option is specified, the trigger is fired for each action on a record of the dependent file.

22. The computer system of claim 21, wherein, if the STATEMENT option is specified, the trigger is fired once for a SQL statement that starts the DELETE CASCADE.

23. The computer system of claim 19, further comprising instructions to delete a record in a parent file of the dependent files before deleting the records in the dependent files.

24. The computer system of claim 17, wherein the trigger either fires before deleting a record in one of the dependent files, or fires after deleting a record in one of the dependent files.
